(19) United States
(12) Patent Application Publication
(10) Pub. No.: US 2016/0172001 A1
(43) Pub. Date: Jun. 16, 2016

(54) GENERATING STATIC VIEWS AS A MOTION FILE

(71) Applicant: Collaaj, Inc., Santa Clara, CA (US)

(72) Inventor: Aditya R Kadambi, Bangalore (IN)

(21) Appl. No.: 14/569,115

(22) Filed: Dec. 12, 2014

(51) Int. Cl. G11B 27/031

(52) U.S. Cl. CPC G11B 27/031

(57) ABSTRACT

The embodiments herein provide a method and system for generating static views of one or more objects on an electronic device as a motion file. The method includes rendering the object(s) on the electronic device, wherein the object includes a static view. Further method includes capturing the static view associated with the object, wherein the static view is captured at end of the object rendering on said electronic device. Furthermore, the method includes appending the captured static view to generate the motion file.

### TECHNICAL FIELD

The embodiments herein relate to screen recording systems/applications and, more particularly, to a mechanism for generating static views of an object in an electronic device as a motion file.

### BACKGROUND

In recent years, electronic devices such as smart phones, portable digital assistants (PDA's), phablets, tablets, communicators, gaming devices, portable media devices, and the like are increasing in technological ability and provide multiple functionalities within limited device-space and limited processing power. In other words, the electronic devices have incorporated with many features and applications (for example, cellular services, phonebooks, calendars, games, voicemail, paging, web browsing, video recording, image capturing, voice memos, voice recognition, screen capture and so on) involving processor or memory intensive operations.

Generally, screen capture tools may be used to capture video images displayed on a graphical user interface of a display. In conventional systems, the tools can be configured to grab frame images of the screen of the electronic at a specific frame rate. For example, if the frame rate is 15 frames per second then the tool grabs 15 frame images of the screen for every second. Later, a video container including the grabbed frame images can be created. But, due to limited processing capability of the device, the some of the frame images may be dropped while grabbing the frame images which may results in a poor quality of the video. Further, existing screen recording tools or applications may continuously capture frame images at a specified frame rate irrespective of whether any interaction on the screen is performed. Furthermore, capturing dynamic sequential screens of a computer system when the user is still interacting or the information is still rendering on the screen may unnecessary increasing the overall processing load of the system. Hence, there is a need to prevent the dropping of the frames in the electronic devices to get good quality of screen capture video by decreasing the load on the processor of the electronic device.

### OBJECT OF INVENTION

The principal object of the embodiments herein is to provide a system and method for generating static views of an object in an electronic device as a motion file.

Another object of the embodiments herein is to provide a mechanism for capturing static views of an object at end of user interaction with an electronic device.

Another object of the embodiments herein is to provide a mechanism for capturing static views after completely rendering one or more objects on an electronic device.

Another object of the embodiments herein is to provide a system and method for capturing screen image of objects displayed on an electronic device, wherein the screen image indicates a static view of the objects displayed on the electronic device.

Another object of the embodiments herein is to provide a system and method for providing static information on an electronic device as motion.

### SUMMARY

Accordingly, the embodiment herein provides a method for generating static views of one or more objects on an electronic device as a motion file. The method includes rendering the object(s) on the electronic device, wherein the object includes a static view. Further method includes capturing the static view associated with the object, wherein the static view is captured at end of the object rendering on said electronic device. Furthermore, the method includes appending the captured static view to generate the motion file.

Accordingly, embodiment herein provides an electronic device for generating a motion file including a plurality of static views associated with one or more objects. The electronic device includes an interface module configured to render the objects(s), wherein the object includes a static view. Further, the electronic device includes a screen capturing module configured to capture the static view associated with the object, wherein the static view is captured at end of the object rendered on the electronic device. Furthermore, the electronic device includes a controller module configured to append the captured static view to generate the motion file.

Accordingly, embodiment herein provides a computer program product including computer executable program code recorded on a computer readable non-transitory storage medium, the computer executable program code when executed causing the actions including rendering one or more object on the electronic device, wherein the object includes one or more static views. Further, the computer executable program code when executed causing the actions including capturing the static view associated with the object, wherein the static view is captured at end of the object rendering on the electronic device. Further, the computer executable program code when executed causing the actions including appending the static view to generate the motion file.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of an electronic device, as disclosed in the embodiments herein;

FIG. 2 is a flow diagram illustrating a method for generating static views of an electronic device as a motion file in an electronic device, as disclosed in the embodiments herein;

FIGS. 3a-3e illustrate an example scenario of generating static views of slides in a presentation displayed on an electronic device as a motion file, as disclosed in the embodiments herein;

FIGS. 4a-4e illustrates another example scenario of generating static views of data available on a webpage as a motion file, as disclosed in the embodiments herein; and

FIG. 5 illustrates a computing environment implementing the method and system according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Prior to describing the embodiments in detail, it is useful to provide definitions for key terms and concepts used herein. Unless defined otherwise, all technical and scientific terms used herein have the same meaning as commonly understood by a personal having ordinary skill in the art to which this invention belongs.

Electronic device: Refers to a general purpose computer including sufficient firmware to generate the static views of the objects as a motion file. More particularly, the electronic device refers to a smart phone or any portable electronic device.

Event: Refers to action or occurrence of an operation in an electronic device in response to an internal or external notable occurrence at any given instant. Each event may be associated with specific operation to be performed in the electronic device. The internal event may generated automatically by the electronic device or any other application in the device. The external event may be generated by gestures or any other operation performed by a user.

Object: Refers to screen of the electronic device including text, slides, icons, applications, graphical user interface, and the like. Each object is configured to include a static view representing the static information on the screen.

Static view: Refers to view acquired after all the information related to the object is completely displayed on the screen of the electronic device. In other words, the screen obtained after completely displaying the object(s) on the electronic device. More particularly, the static view may represent a static image of the objects displayed on the electronic device.

The embodiments herein disclose a method and system for generating static views of objects displayed on an electronic device as a motion file. In an embodiment, the electronic device can be configured to include an interface module, a screen capturing module, a controller module, and a storage module. The method includes rending one or more objects on an electronic device and capturing static view(s) of the object. Unlike conventional systems, the objects on the electronic device is captured after completely rendering the objects on the electronic device (i.e., a static view of the object is captured at end of the object rendering on the display of the electronic device). Further, the electronic device is configured to append the captured static views of the object to generate the motion file.

The system and method described herein is simple and robust for providing the static information as motion. The electronic device disclosed herein captures a single static view of the object after the object is completely rendered on the display of the electronic device. Unlike conventional systems, where the frames are captured based on a specific frame rate irrespective of the object are displayed or in the process rendering on the screen, the system and method can be used to capture a single frame image only after the complete information is rendered on the screen of the electronic device thereby avoiding any dynamic information which is yet to be displayed on the screen. For example, when an electronic device needs to display 100 files, the electronic device may take some time based on the processing capabilities. The system can be used to record the frame image only after all the 100 files are rendered on the screen of the electronic device. In other words, the electronic device may not capture the frame image of the object while the object is still rendering on the screen of the electronic device. Thus, the system and method can used to capture only one image frame of the static information rendered on the electronic device. The system and method can be use more particularly, in the electronic devices where complex processing is involved. The capturing of single frame after the information is completely displayed on the electronic device is further to decrease load on processor instead of capturing the frames based on a specific frame rate. Further, the proposed system and method can be readily implemented on the existing infrastructure and does not require extensive set-up or instrumentation.

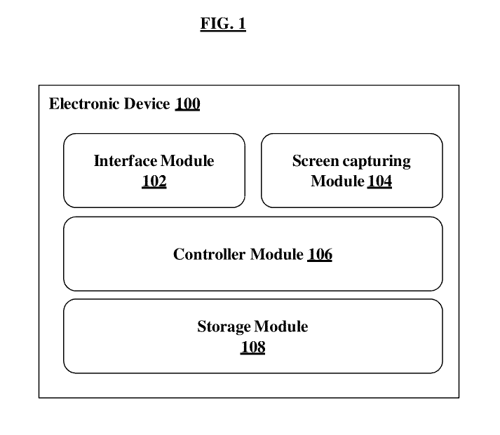

Referring now to the drawings, and more particularly to FIGS. 1 through 5, where similar reference characters denote corresponding features consistently throughout the figures, there are shown embodiments.

FIG. 1 illustrates a block diagram of an electronic device 100, according to embodiments as disclosed herein. In an embodiment, the electronic device 100 such as a mobile device can be configured to include an interface module 102, a screen capturing module 104, a controller module 106, and a storage module 108. The electronic device 100 described herein can be for example, but not limited to desktop computer, laptop, smart phone, portable digital assistant (PDA), pager, tablet, communicator, messenger device, gaming device, and the like. The interface module 102 can be configured to provide Graphical User Interface (GUI) used to render objects on screen of the electronic device 100. In an embodiment, the interface module 102 can be configured to provide various adaptors, connectors, channels, communication paths, and the like, such as to provide communication between the user and the electronic device 100. The interface module 102 can be an input/output module which can be configured to receive inputs and deliver outputs to the user by using a suitable user interface. For example, the interface module 102 may allow the user to provide the inputs through a touch screen, a keyboard, a mouse, or any other suitable input device. Further, the interface module 102 may deliver output to the user through a display screen which includes sufficient firmware to provide the output to the user. In an embodiment, the interface module 102 can be configured to render an object on the display of the electronic device 100. In an embodiment, the object can be, for example, but not limited to, screen of the electronic device including text, slides, icons, applications, graphical user interface, and the like. Each object is configured to include a static view representing the static information on the screen.

In an embodiment, the object can be rendered automatically based on an internal event in the electronic device 100. For example, the internal event can include, for example, but not limited to, application management, alert management, background functions, and so on. Each event may be associated with specific operation to be performed in the electronic device 100. In an embodiment, the object can be rendered manually based on an external event provided by the user to the electronic device 100. For example, the external event can be user's multi-touch gestures tapping, long press, scrolling, flicking, pinching, rotating, and so on to perform specific operations in the electronic device 100.

The screen capturing module 104 can be configured to capture a static view of the object at end of its rendering on the display of the electronic device 100. The static view described herein can be a view acquired after all the information related to the object is completely displayed on the screen of the electronic device 100. In other words, the screen obtained after completely displaying the object(s) on the electronic device. More particularly, the static view may represent a static image of the objects displayed on the electronic device 100. In an embodiment, capturing the static view of the objects may include capturing a screen shot of the objects displayed on the electronic device 100.

The controller module 106 can be configured to append the captured static view of the object with other captured static views of the object. The controller module 106 can be further configured to generate a motion file of the captured static views of the object by stitching the static views of the objects displayed on the electronic device 100. In an embodiment, the motion file described herein can be any suitable video container like MP4, 3GP, AVI, and so on. The moving file can be configured to include the static views of the object, such as to present the static information as motion to the user. Further, the generated motion file can be played back on the display of the electronic device 100 which shows the captured static views of the object as motion.

The storage module 108 can be configured to store the generated motion file and captured static views of the object. Further, the storage module 108 can be configured to include sufficient instructions and firmware used to capture and generate static views of the objects displayed on the electronic device as motion.

The FIG. 1 shows an example overview of the electronic device 100 but, it is to be understood that another embodiment is not limited thereto. Further, the electronic device 100 can include different modules (not shown) communicating among each other along with other hardware or software components. For example, the component can be, but not limited to, a process running in the electronic device 100, an executable process, a thread of execution, a program, and/or a computer. By way of illustration, both an application running on an electronic device 100 and the electronic device 100 can be the component.

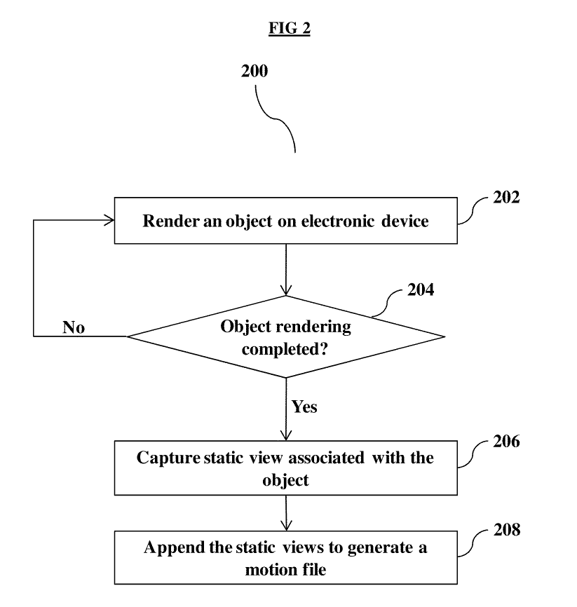

FIG. 2 is a flow diagram illustrating a method 200 for generating a motion file in an electronic device, as disclosed in the embodiments herein. The method 200 and other description described herein provide a basis for a control program which can be easily implemented using a microcontroller, microprocessor, or an equivalent thereof. At step 202, the method 200 includes rendering an object on the electronic device 100. The method 200 allows the interface module 102 to render the object on the electronic device 100. In an embodiment, the object can be rendered automatically based on an internal event in the electronic device 100. In an embodiment, the object can be rendered manually based on an external event performed by the user on the electronic device 100. At step 204, the method 200 includes determining whether the objects are completely rendered on the electronic device 100. The method 200 allows the controller module 106 to determine whether the object gets completely rendered on the display of the electronic device 100. For example in order to navigate a document from first page to tenth page, the user may scroll the screen. The electronic device 100 may dynamically changes the screen images to reach to the tenth page in response to receiving any external event from the user to scroll the pages. The electronic device 100 scrolls the document by navigating from first page of document to second page of document following the page and stops at the tenth page. While the pages are still rendering on the display to reach the tenth page, the controller module 106 continuously monitors the screen to determine whether the rendering of the page is completed on the display of the electronic device 100.

At step 206, the method 200 includes capturing a static view of the object if the controller module 106 detects that the object gets completely rendered on the display of the electronic device 100. Unlike conventional systems, where the frames are captured based on a specific frame rate irrespective of the object are displayed or in the process rendering on the screen, the electronic device 100 can be used to capture a single frame image only after the complete information is rendered on the screen of the electronic device thereby avoiding any dynamic information which is yet to be displayed on the screen. The method 200 allows the screen capturing module 104 to capture the static view of the object at end of its rendering on screen of the electronic device 100. The method 200 allows the controller module 106 to continuously determine whether the objects are completely rendered on the electronic device 100. In response to determining that the objects are completely rendered on the electronic device 100, the method 200 allows the screen capturing module 104 to capture the static view of the completely displayed objects on the screen.

At step 208, the method 200 includes appending the captured static views to generate a motion file. The method 200 allows the controller module 106 to append the captured static views of the object into a suitable video container like MP4, 3GP, AVI, and the like to generate the motion file.

The various actions, acts, blocks, steps, and the like in method 200 may be performed in the order presented, in a different order or simultaneously. Further, in some embodiments, some actions, acts, blocks, steps, and the like may be omitted, added, modified, skipped, and the like without departing from the scope of the invention.

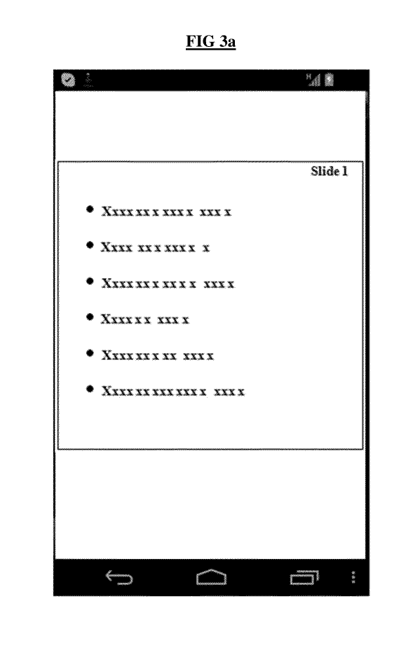

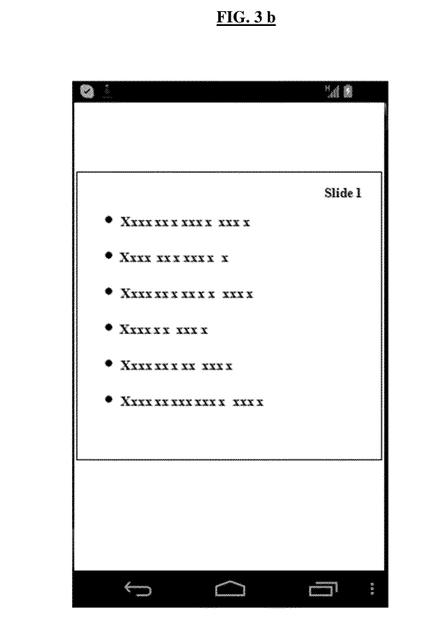

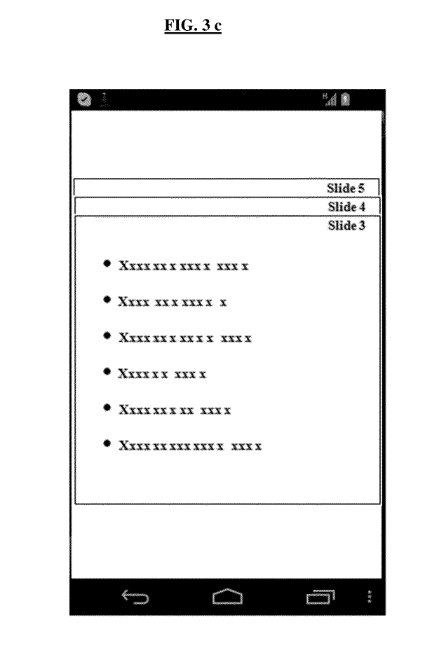

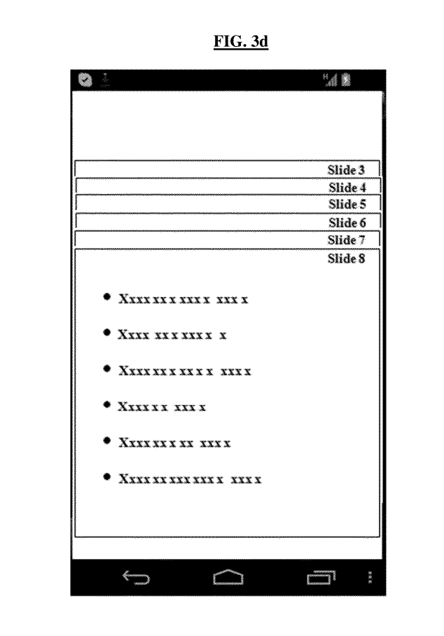

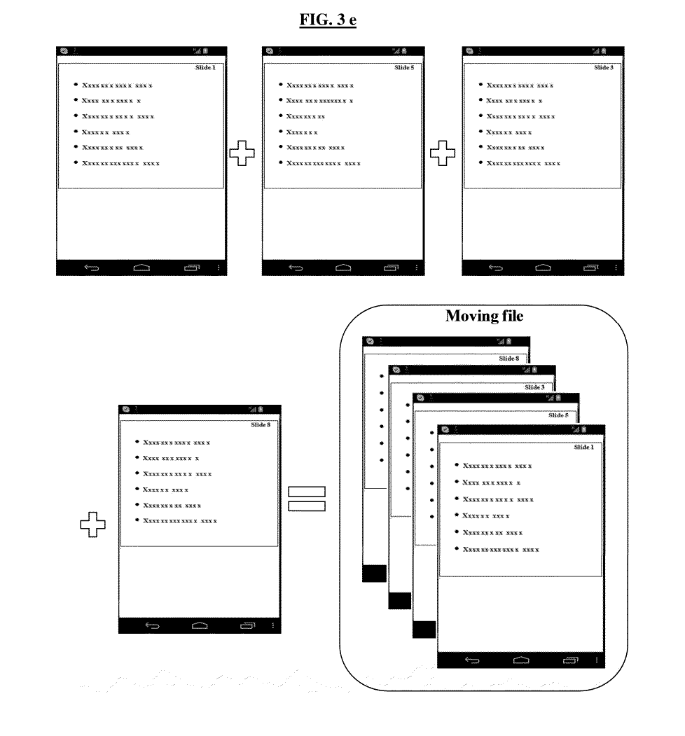

FIGS. 3a-3e illustrate an example scenario of generating static views of slides in a presentation displayed on an electronic device as a motion file, as disclosed in the embodiments herein. In an embodiment, consider an example scenario in which a user is interacting with an application in an electronic device like smart phone. Further, the smart phone can render the object (like a presentation including various slides) on the screen and capture a static view of the object displayed on the smart phone after the slide(s) is completely rendered on the smart phone. Consider that presentation include 8 slides. Initially, assume that the user is on slide-1 as shown in the FIG. 3a. The screen capturing module 104 can capture the frame image displaying the slide-1 after the slide-1 is completely displayed on the screen of the smart phone.

Assume that the user scrolls the display of the mobile device to view the slide-5 on the screen. On receiving input (via a touch or any other means) from the user to navigate the slideshow or presentation to the slide-5, the screen gets iterated from the slide-1 to the slide-5 by sliding the slide-2, slide-3, and slide-4 and stops at the slide-5, such as shown in the FIG. 3b. The screen capturing module 104 can capture the frame image displaying the slide-5 after the slide-5 is completely displayed on the screen of the smart phone thereby avoiding the frame images of the slide-2, slide-3, and slide-4. Further, assume that the user scrolls back to the slide-3 after viewing the slide-5. On receiving input (via a touch or any other means) from the user to navigate the slideshow or presentation to the slide-3, the screen gets iterated from the slide-5 to the slide-3 by sliding the slide-4 and stops at the slide-3, such as shown in the FIG. 3c. Here, the screen capturing module 104 can capture the frame image of screen displaying the slide-3 after the slide-3 is completely displayed on the screen of the smart phone thereby avoiding the frame images of the slide-4.

Further, assume that the user again scrolls the display of the smart phone to view the slide-8. On receiving input (via a touch or any other means) from the user to navigate the slideshow or presentation to the slide-8, the screen gets iterated from the slide-3 to the slide-8 by sliding the slide-4, slide-5, slide-6, and slide-7 and stops at the slide-8, such as shown in the FIG. 3d. Here, the screen capturing module 104 can capture the frame image displaying the slide-8 after the slide-8 is completely displayed on the screen of the smart phone thereby avoiding the frame images of the slide-4, slide-5, slide-6, slide-7, and slide-8.

Note that the controller module 106 can be configured to continuously monitor the screen of the smart phone to determine whether the slide is completely rendered on the screen before allowing the screen capturing module 104 to capture the frame images of the smart phone screen. Unlike conventional systems, where the frames are captured based on a specific frame rate irrespective of the object are displayed or in the process rendering on the screen, the controller module 106 can be used to capture a single frame image only after the complete information is rendered on the screen thereby avoiding any dynamic information which is yet to be displayed on the screen. For example, when the slides are navigating from the slide-1 to the slide-5, the screen capturing module 104 does not capture the slides 2, 3, and 4 as the rendering is not completed on the display of the smart phone. Similarly, when the slides are navigating from the slide-5 to the slide-3, the screen capturing module 104 does not capture the slide 4 as the rendering is not completed on the display of the smart phone. Similarly, when the slides are navigating from the slide-3 to the slide-8, the screen capturing module 104 does not capture the slides 4, 5, 6, and 7 as the rendering is not completed on the display of the smart phone. Further, the controller module 106 can be configured to append the static views to generate the moving file. A video container including the captured static views of the slides 1, 5, 3, and 8 is generated by stitching them together as shown in the FIG. 3e.

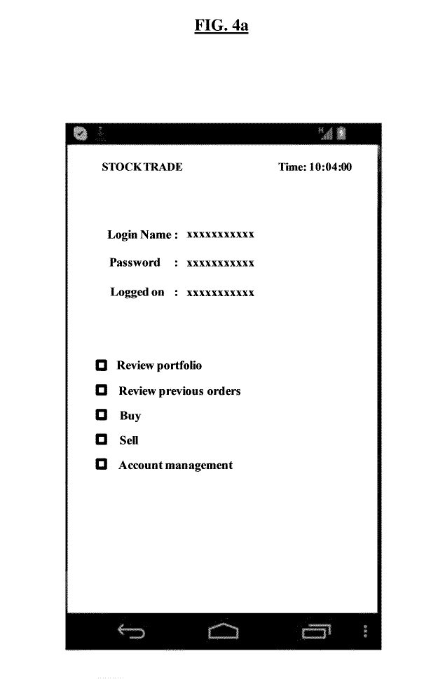

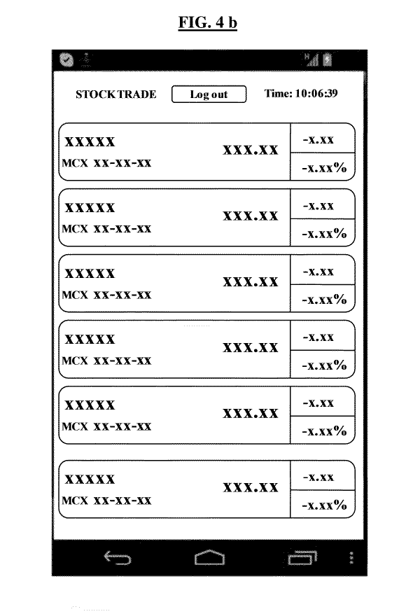

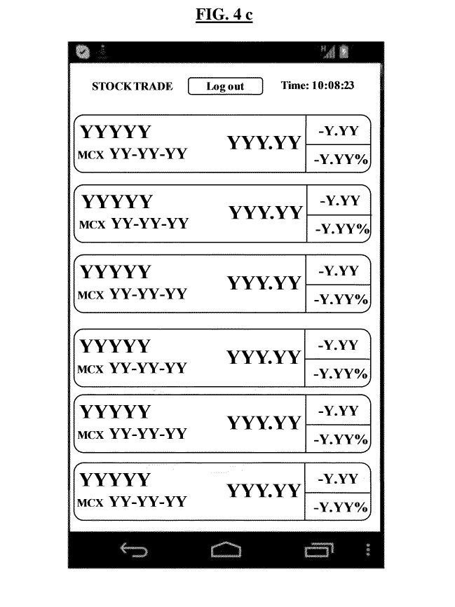

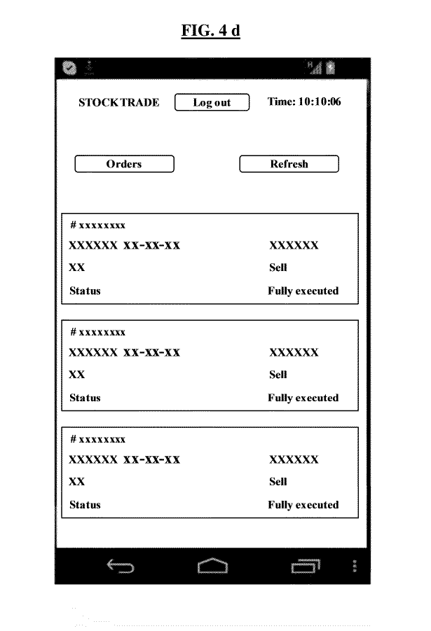

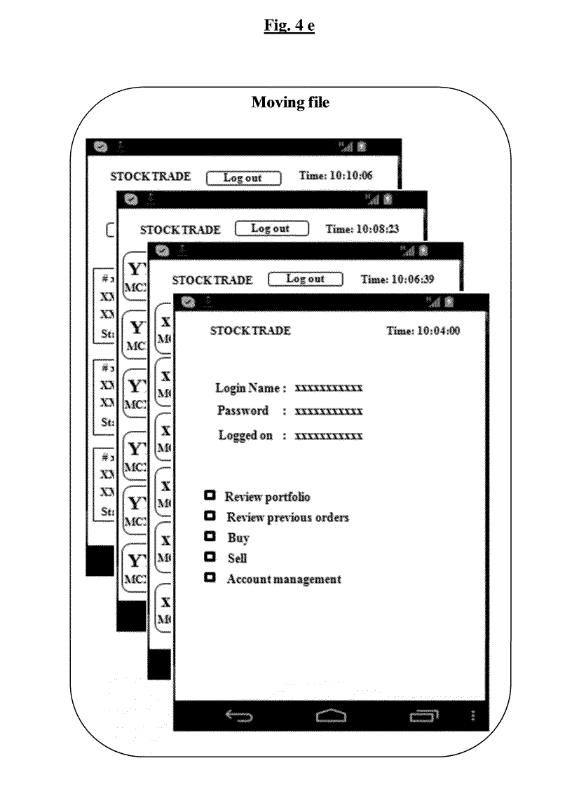

FIGS. 4a-4e illustrates another example scenario of generating static views of data available on a webpage as a motion file, as disclosed in the embodiments herein. In an embodiment, consider another example scenario in which a user is interacting with an application in an electronic device like a mobile device. The mobile device can be configured to capture a static view of the object on the display of the mobile device whenever the rendering of the objects are completely rendered on the display. Consider the application as a web-based stock trade. Assume that the user opens a web page to provide login details such as shown in the FIG. 4a. The FIGS. 4b, 4c, and 4d illustrates various operations performed by the user and the associated information displayed on the mobile device.

Note that the controller module 106 can be configured to continuously monitor the screen of the mobile device to determine whether the information on the web page is completely rendered on the screen before allowing the screen capturing module 104 to capture the frame images of the smart phone screen. Further, the controller module 106 can be configured to append the static views to generate the moving file. A video container including the captured static views of the web pages at different time instances as shown in FIGS. 4b, 4c, and 4d is generated by stitching them together as shown in the FIG. 4e.

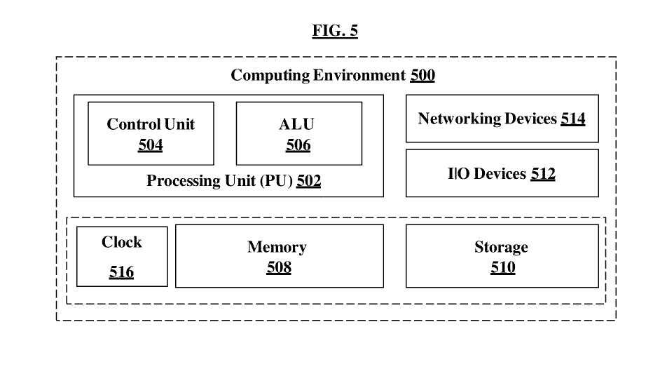

FIG. 5 illustrates a computing environment implementing the method of generating a motion file in an electronic device, according to the embodiments as disclosed herein. As depicted in the figure, the computing environment 500 comprises at least one processing unit 502 that is equipped with a control unit 504 and an Arithmetic Logic Unit (ALU) 506, a memory 508, a storage unit 510, plurality of networking devices 512 and a plurality Input output (I/O) devices 514. The processing unit 502 is responsible for processing the instructions of the algorithm. The processing unit 502 receives commands from the control unit 504 in order to perform its processing. Further, any logical and arithmetic operations involved in the execution of the instructions are computed with the help of the ALU 506.

The algorithm comprising of instructions and codes required for the implementation are stored in either the memory unit 508 or the storage 510 or both. At the time of execution, the instructions may be fetched from the corresponding memory 508 and/or storage 510, and executed by the processing unit 502.

In case of any hardware implementations various networking devices 514 or external I/O devices 512 may be connected to the computing environment to support the implementation through the networking unit and the I/O device unit. The embodiments disclosed herein can be implemented through at least one software program running on at least one hardware device and performing network management functions to control the network elements.

The embodiment disclosed herein specifies a method for generating a motion file in an electronic device. The method allows capturing static view of an object at end of rendering of the object on the display of the electronic device providing a system thereof. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for generating a motion file comprising a plurality of static views associated with at least one object in an electronic device, the method comprising:
rendering said at least one object on said electronic device, wherein said object comprises at least one said static view;
capturing at least one said static view associated with said at least one object, wherein at least one said static view is captured at end of said at least one object rendering on said electronic device; and
appending at least one said static view to generate said motion file.

2. The method of claim 1, wherein said motion file is a video container.

3. The method of claim 1, wherein said method further comprises playback said motion file to display at least one said static view of said at least one object as motion.

4. The method of claim 1, wherein said at least one object is rendered automatically based on an internal event in said electronic device.

5. The method of claim 1, wherein said at least one object is rendered manually based on an external event in said electronic device.

6. The method of claim 1, wherein capturing at least one said static view associated with said at least one object further comprises:
capturing at least one screen snap shot associated with said at least one object displayed on said electronic device, wherein said screen snapshot indicates at least one said static view of said at least one displayed object.

7. An electronic device for generating a motion file comprising a plurality of static views associated with at least one object, the electronic device comprising:
an interface module configured to render said at least one object on said electronic device, wherein said object comprises at least one said static view;
a screen capturing module configured to capture at least one said static view associated with said at least one object, wherein at least one said static view is captured at end of said at least one object rendered on said electronic device; and
a controller module configured to append at least one said static view to generate said motion file.

8. The electronic device of claim 7, wherein said motion file is a video container.

9. The electronic device of claim 7, wherein said controller module is further configured to playback said motion file to display at least one said static view of said at least one object as motion.

10. The electronic device of claim 7, wherein said at least one object is rendered automatically based on an internal event in said electronic device.

11. The electronic device of claim 7, wherein said at least one object is rendered manually based on an external event in said electronic device.

12. The electronic device of claim 7, wherein capture at least one said static view associated with said at least one object further comprises:
capture at least one screen snap shot associated with said at least one object displayed on said electronic device, wherein said screen snapshot indicates at least one said static view of said at least one displayed object.

13. A computer program product comprising computer executable program code recorded on a computer readable non-transitory storage medium, said computer executable program code when executed causing the actions including:
rendering said at least one object on said electronic device, wherein said object comprises at least one said static view;
capturing at least one said static view associated with said at least one object, wherein at least one said static view is captured at end of said at least one object rendering on said electronic device; and
appending at least one said static view to generate said motion file.

14. The computer program product of claim 13, wherein said motion file is a video container.

15. The computer program product of claim 13, wherein said computer executable program code when executed further causing the actions including playback said motion file to display at least one said static view of said at least one object as motion.

16. The computer program product of claim 13, wherein said at least one object is rendered automatically based on an internal event in said electronic device.

17. The computer program product of claim 13, wherein said at least one object is rendered manually based on an external event in said electronic device.

18. The computer program product of claim 13, wherein capturing at least one said static view associated with said at least one object further comprises:
capturing at least one screen snap shot associated with said at least one object displayed on said electronic device, wherein said screen snapshot indicates at least one said static view of said at least one displayed object.
